(19) United States
(12) Patent Application Publication
(10) Pub. No.: US 2005/0276603 A1
(43) Pub. Date: Dec. 15, 2005

(54) Self-monitoring passive optical network

(76) Inventors: Dae-Kwang Jung, Suwon-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(21) Appl. No.: 10/988,823

(22) Filed: Nov. 15, 2004

(30) Foreign Application Priority Data
Jun. 15, 2004 (KR) 2004-43996

(51) Int. Cl. H04J 14/00

(52) U.S. Cl. 398/71

(57) ABSTRACT

A passive optical network is disclosed. The network includes a plurality of subscriber units that generate upstream optical signals, respectively, reflect channels applied thereto in association with the subscriber units, respectively, and detect downstream optical signals associated with the subscriber units, respectively, and a central office that output a multiplexed downstream optical signal and a monitoring light, and detects a multiplexed channel signal. The network also includes a remote node that demultiplexes the monitoring light into different channels, outputs the channels to the subscriber units, respectively, multiplexes the channels, which are reflected from the subscriber units, generates the multiplexed channel signal, and outputs the multiplexed channel signal to the central office. The network further includes a first main optical fiber linking the central office and the remote node, and a plurality of second main optical fibers linking the remote node and the subscriber units, respectively.

### CLAIM OF PRIORITY

This application claims priority to an application entitled “SELF-MONITORING PASSIVE OPTICAL NETWORK,” filed in the Korean Intellectual Property Office on Jun. 15, 2004 and assigned Serial No. 2004-43996, the contents of which are hereby incorporated by reference.

### BACKGROUND OF THE INVENTION

1. Field of the Invention

The present invention relates to a passive optical network (PON), and more particularly to a PON having self-monitoring and self-healing functions.

2. Description of the Related Art

A wavelength division multiplexed (WDM) PON can provide ultrahigh-speed broadband communication services, using particular wavelengths assigned to respective subscribers. Such WDM PONs can ensure communication security while being capable of accommodating separate communication services required by a subscriber. In addition, such WDM PONs can accommodate a subsciber's need for expansion of communication capacity. However, such WDM PONs require, for a central office (CO) associated therewith and each optical network unit (ONU) associated therewith, light sources having a particular oscillation wavelength, and wavelength stabilizing circuits adapted to stabilize the wavelength of the light sources, respectively. This results in an increased cost that is imposed on subscribers.

Generally, WDM PONs use a double star type topology to minimize the length of optical lines used therein. In such double star type topologies, a remote node is installed in an area where a plurality of subscribers are distributed within a near distance. The remote node is connected to a central office via a feeder fiber. The subscribers are individually connected to the remote node via distribution fibers.

The central office multiplexes a plurality of downstream optical signals having different wavelengths, and transmits the resultant multiplexed optical signal to the remote node. The remote node demultiplexes the multiplexed downstream optical signal, and sends the resultant demultiplexed optical signals to respective subscribers. The remote node also multiplexes upstream optical signals received from respective subscribers, and transmits the resultant multiplexed optical signal to the central office.

Since the central office and remote node are connected by a single feeder fiber in the above-mentioned WDM PON, if the feeder fiber fails or is degraded, downstream and upstream optical signals, which are transmitted through the feeder fiber, are inevitably lost. In order to minimize damage caused by the failure or degradation of the feeder fiber, a separate low-speed communication network is typically installed between the central office and the remote node in general PONs.

However, the low-speed communication network takes a considerable amount of time to check whether or not there is any abnormality between the central office and the remote node (due to the low-speed communication network used), and to inform a manager of the result of the checking. This means that the amount of time communication is interrupted between the central office and the remote node is prolonged. Therefore, the above-mentioned PON requires a self-healing function to rapidly and reliably heal abnormalities generated within the PON.

FIG. 1 is a block diagram illustrating a conventional, self-healing, bi-directional, ring-type, optical network 100. The conventional, self-healing, ring-type, optical network 100 includes a plurality of nodes 110, 120, 130, and 140 to transmit/receive a first optical signal having wavelengths λ₁ to λ_{N} and a second optical signal having wavelengths λ_{N+1} to λ_{2N} to/from one another, and first and second optical fibers 101 and 102 to link the nodes 110, 120, 130, and 140 in the form of a ring. The first and second optical signals use different wavelength ranges respectively including the wavelengths λ₁ to λ_{N} and the wavelengths λ_{N+1} to λ_{2N}. Each of the nodes 110, 120, 130, and 140 drops an associated channel from the first optical signal input thereto, and outputs the resultant first optical signal. Each of the nodes 110, 120, 130, and 140 also adds a particular channel to the second optical signal, and outputs the resultant second optical signal.

Each of the nodes 110, 120, 130, or 140 includes a first switch 111, 121, 131, or 141, a second switch 112, 122, 132, or 142, a first optical add-drop multiplexer (OADM) 113, 123, 133, or 143 to connect the first switch 111, 121, 131, or 141 and the second switch 112, 122, 132, and 142, and a second OADM 114, 124, 134, or 144 to connect the first switch 111, 121, 131, or 141 and the second switch 112, 122, 132, or 142. Each of the switches may be a 2×2 switch.

Each of the first OADMs 113, 123, 133, and 143 drops an associated channel from the first optical signal, multiplexes the undropped remaining channels of the first optical signal, and outputs the resultant multiplexed optical signal. Each of the second OADMs 114, 124, 134, and 144 adds a particular channel corresponding to a predetermined wavelength to the second optical signal, multiplexes the channel-added second optical signal, and outputs the resultant multiplexed optical signal. The first optical signal is sequentially input to and output from the nodes 110, 120, 130, and 140 via the first optical fiber 101. Similarly, the second optical signal is sequentially input to and output from the nodes 110, 120, 130, and 140 via the second optical fiber 102.

Each of the first switch 111, 121, 131, and 141 receives the first optical signal output from the node connected to an input terminal of the first switch, and outputs the received first optical signal to an associated one of the first OADM 113, 123, 133, and 143. Each of the first switch 111, 121, 131, and 141 also receives the second optical signal from an associated one of the second OADMs 114, 124, 134, and 144, and outputs the received second optical signal to the node connected to an output terminal of the first switch.

In the above-mentioned bi-directional, self-healing, ring-type, optical network 100, even when there is a fault caused by a line failure generated in one of the first and second optical fibers 101 and 102 or a degradation of the constituent elements of the nodes 110, 120, 130, and 140, it is possible to transmit/receive the first and second optical signals through the nodes 110, 120, 130, and 140 by circulating the other optical fiber 102 or 101 by the second switches 112, 122, 132, and 142 or the first switches 111, 121, 131, and 141.

However, if this self-healing optical network architecture is applied to the above-mentioned WDM PON, there are again problems cost burden and bulky size because a plurality of switches and a plurality of multiplexers/demultiplexers must be additionally used. Furthermore, conventional optical communication systems having a self-healing or monitoring means have a problem in that it is impossible to accurately identify a correct cause of optical signal disturbance.

### SUMMARY OF THE INVENTION

One aspect of the present invention relates to a PON capable of tracing a cause of signal disturbance and healing the cause.

One embodiment of the present invention is directed to a passive optical network including a plurality of subscriber units that generate upstream optical signals, respectively, and reflect channels applied thereto in association with the subscriber units, respectively, and that receive downstream optical signals associated with respective subscriber units; a central office that outputs a multiplexed downstream optical signal and a monitoring light and that detects a multiplexed channel signal; a remote node that demultiplexes the monitoring light into different channels, outputs the channels to the subscribers, respectively, multiplex the channels from the subscriber units, generate the multiplexed channel signal, and output the multiplexed channel signal to the central office; a first main optical fiber linking the central office and the remote node; and a plurality of second main optical fibers linking the remote node and the subscriber units, respectively.

Another embodiment of the present invention is directed to a passive optical network including a plurality of subscriber units that generate upstream optical signals, respectively, reflect channels applied thereto in association with the subscriber units, respectively, and detect downstream optical signals associated with the subscriber units, respectively; and a central office that outputs a multiplexed downstream optical signal and a monitoring light, and detects a multiplexed channel signal. The network also includes a remote node that demultiplexes the monitoring light into different channels, output the channels to the subscriber units, respectively, multiplexes the channels, which are reflected from the subscriber units, generates the multiplexed channel signal, and outputs the multiplexed channel signal to the central office; a first main optical fiber linking the central office and the remote node; a plurality of second main optical fibers linking the remote node and the subscribers, respectively; a first auxiliary optical fiber used to transmit the multiplexed downstream optical signal and the monitoring light to the remote node when a fault occurs in the first main optical fiber, and to transmit a multiplexed signal of the upstream optical signals and a multiplexed signal of the channels to the central office when the fault occurs; and a plurality of second auxiliary optical fibers each used to transmit an associated one of demultiplexed signals of the multiplexed downstream optical signal to an associated one of the subscriber units and transmit the upstream optical signal generated from the associated subscriber unit and the channel reflected from the associated subscriber unit to the remote node when a fault occurs in an associated one of the second main optical fibers.

### BRIEF DESCRIPTION OF THE DRAWINGS

The above aspects and embodiments of the present invention will become more apparent by describing in detail embodiments thereof with reference to the attached drawings in which:

FIG. 1 is a block diagram illustrating a conventional self-healing bi-directional ring type optical network;

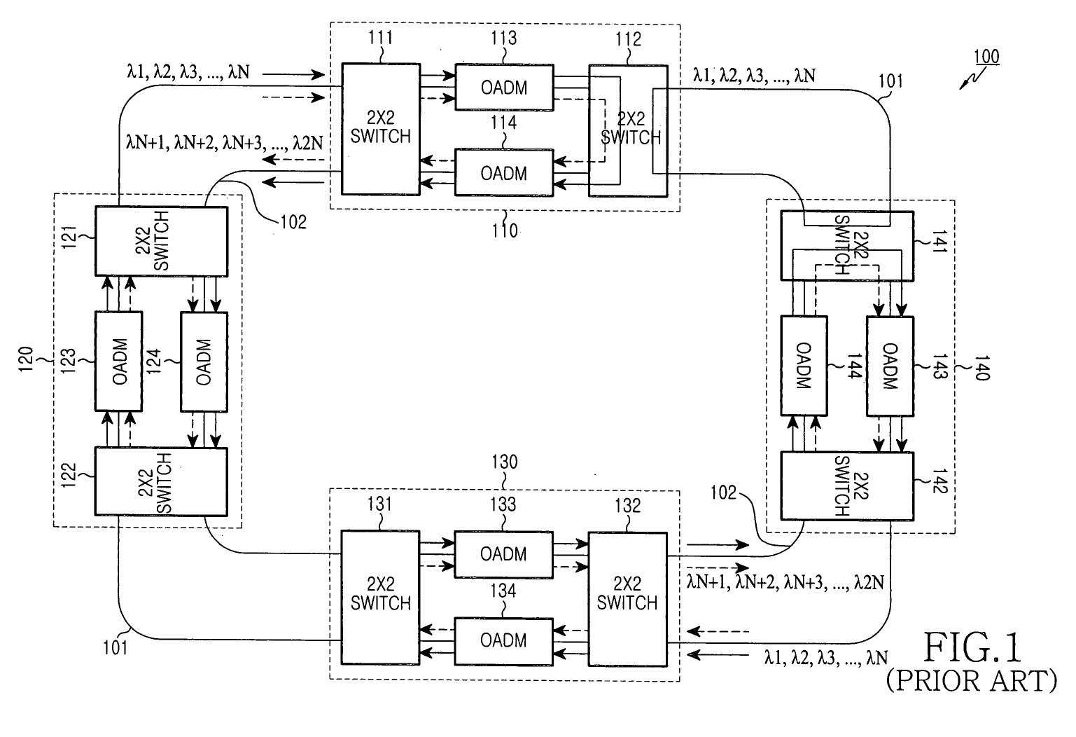

FIG. 2 is a block diagram illustrating a WDM PON having self-monitoring and self-healing functions in accordance with a first embodiment of the present invention; and

FIG. 3 is a block diagram illustrating a WDM PON having self-monitoring and self-healing functions in accordance with a second embodiment of the present invention.

### DETAILED DESCRIPTION

Now, embodiments of the present invention will be described in detail with reference to the annexed drawings. In the following description of the present invention, a detailed description of known functions and configurations incorporated herein will be omitted when it may obscure the subject matter of the present invention.

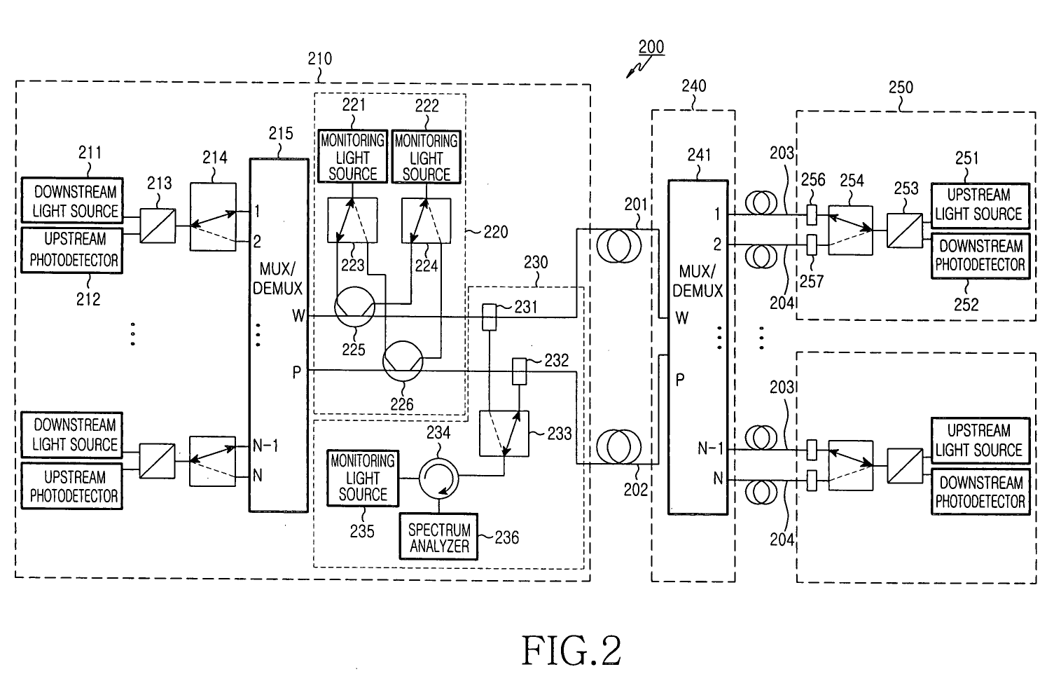

FIG. 2 is a block diagram illustrating a WDM PON having self-monitoring and self-healing functions in accordance with a first embodiment of the present invention. As shown in FIG. 2, the WDM PON 200 includes a plurality of subscribers 250 that generate upstream optical signals, and detect downstream optical signals associated with the subscribers 250, respectively, a central office 210 that generates a multiplexed downstream optical signal and detects upstream optical signals, and a remote node 240 that performs a relay operation between the subscribers 250 and the central office 210. The WDM PON 200 also includes a first main optical fiber 201 and a first auxiliary optical fiber 202 to link the central office 210 and the remote node 240, and a plurality of second main optical fibers 203 and a plurality of second auxiliary optical fibers 204 to link the remote node 240 and respective subscribers 250. The central office 210 generates a monitoring light to monitor generation of a fault in the WDM PON 200 and cause of the fault. The remote node 240 demultiplexes the monitoring light into channels of different wavelengths, and outputs the demultiplexed channels to the subscribers 250, respectively. Each subscriber 250, which receives the channel from the remote node 240, reflects the received channel to the remote node 240. The remote node 240 multiplexes the reflected channels received from respective subscribers 250, and outputs the multiplexed channel signal to the central office 210. Accordingly, the central office 210 can monitor whether or not there is a fault in the WDM PON 200 by determining whether or not the channel transmitted from each subscriber 250 has been detected.

When a fault occurs in the first main optical fiber 201, the first auxiliary optical fiber 202 transmits the multiplexed downstream optical signals and the monitoring light to the remote node 240, while transmitting the multiplexed upstream optical signals and channels from the remote node 240 to the central office 240.

When there is a fault in one of the second main optical fibers 203, which is connected between the remote node 240 and an associated one of the subscribers 250, the second auxiliary optical fiber 204 associated with the faulty second main optical fiber 203 transmits the associated demultiplexed downstream optical signal to the associated subscriber 250, while transmitting, to the remote node 240, the upstream optical signal generated from the associated subscriber 250 and the channel reflected from the associated subscriber 250.

The central office 210 includes a plurality of downstream light sources 211, a plurality of upstream photodetectors 212, a monitor 230 generates the monitoring light and detects respective channels transmitted form the subscribers 250, a first multiplexer/demultiplexer (MUX/DEMUX) 215, first wavelength-selective couplers 213, first switches 214, and a broadband optical module 220 wavelength-lock the downstream light sources 211 and subscribers 250.

The first MUX/DEMUX 215 multiplexes the downstream optical signals input to the central office 210, and outputs the resultant multiplexed downstream optical signal to the remote node 240. The first MUX/DEMUX 215 also demultiplexes the multiplexed upstream optical signal input to the central office 210, and outputs the resultant demultiplexed upstream optical signals to the upstream photodetectors 212, respectively.

The downstream light sources 211 generate wavelength-locked downstream optical signals, respectively. Each upstream photodetector 212 detects an associated one of the upstream optical signals demultiplexed by the first MUX/DEMUX 215.

Each first wavelength-selective coupler 213 outputs an associated one of the demultiplexed upstream optical signals to an associated one of the upstream photodetectors 212. Each first wavelength-selective coupler 213 also outputs the downstream optical signal generated from an associated one of the downstream light source 211 to the first MUX/DEMUX 215.

Each first optical switch 214 is arranged between an associated one of the first wavelength-selective coupler 213 and the first MUX/DEMUX 215 to selectively connect the associated first wavelength-selective coupler 213 to a desired one of at least two ports of the fist MUX/DEMUX 215 assigned to the associated first wavelength-selective coupler 213.

The monitor 230 includes a monitoring light source 235, a spectrum analyzer 236, a second wavelength-selective coupler 231, a third wavelength-selective coupler 232, a second optical switch 233, and a circulator 234. Using this configuration, the monitor 230 can generate a monitoring light, and detects channels reflected from respective subscribers 250.

The monitoring light source 235 generates a monitoring light having a plurality channels with different wavelengths. The spectrum analyzer 236 demultiplexes the multiplexed channel signal received from the remote node 240, and detects the resultant demultiplexed channels.

The second wavelength-selective coupler 231 connects the first main optical fiber 201 and the monitor 230 so that the monitoring light can be output to the remote node 240 via the first main optical fiber 201. The multiplexed channel signal received from the remote node 240 is also output to the second optical switch 233 via the second wavelength-selective coupler 231. The second wavelength-selective coupler 231 also transmits the multiplexed downstream optical signal from the central office 230 to the remote node 240, and transmits the multiplexed upstream optical signal from the remote node 240 to the central office 210.

The third wavelength-selective coupler 232 connects the first auxiliary optical fiber 202 and the monitor 230 so that the monitoring light can be output to the remote node 240 via the first auxiliary optical fiber 202. The multiplexed channel signal received from the remote node 240 is also output to the second optical switch 233 via the third wavelength-selective coupler 232. The third wavelength-selective coupler 232 also transmits the multiplexed downstream optical signal from the central office 230 to the remote node 240, and transmits the multiplexed upstream optical signal from the remote node 240 to the central office 210.

The second optical switch 233 selectively outputs the monitoring light received from the circulator 243 to the second wavelength-selective coupler 231 or third wavelength-selective coupler 232, and outputs, to the circulator 234, the multiplexed channel signal received from the second or third wavelength-selective coupler 231 or 232.

The circulator 234 outputs the monitoring light generated from the monitoring light source 235 to the second optical switch 233, and outputs the multiplexed channel signal received from the second optical switch 233 to the spectrum analyzer 236.

The spectrum analyzer 236 analyzes whether or not each channel has been detected. The result of the analysis is used to recognize whether or not there is a fault in the subscriber 250 associated with the channel. It is possible to determine whether the fault is based on a line failure generated in one of the first and second main optical fibers 201 and 203, and first and second auxiliary optical fibers 202 and 204, or a failure or degradation of one of the above-described constituent elements, by comparing the determination result as to whether or not the associated upstream optical signal has been detected and the determination result as to whether or not the associated channel has been detected.

The broadband optical module 220 includes a first broadband light source 221 that generates a downstream light to induce wavelength-locking of the multiplexed downstream optical signal, a second broadband light source 222 that generates an upstream light to induce wavelength-locking of the multiplexed upstream optical signal, a first optical distributor 225, a second optical distributor 226, a fourth optical switch 223, and a fifth optical switch 224.

The first optical distributor 225 is arranged on the first main optical fiber 201 so that the downstream light can be output to the first MUX/DEMUX 215 and the upstream light can be output to the second wavelength-selective coupler 231. The second optical distributor 226 is arranged on the first auxiliary optical fiber 202 so that the upstream light can be output to the third wavelength-selective coupler 232 and the downstream light can be output to the first MUX/DEMUX 215.

The fourth optical switch 223 selectively connects the first broadband light source 221 to the first optical distributor 225 or second optical distributor 226. The fifth optical switch 224 selectively connects the second broadband light source 222 to the first optical distributor 225 or second optical distributor 226.

The remote node 240 includes a second MUX/DEMUX 241. The second MUX/DEMUX 241 is linked to the central office 219 via the first main optical fiber 201 and first auxiliary optical fiber 202. The second MUX/DEMUX 241 is also linked to the subscribers 250 via the second main optical fibers 203 and second auxiliary optical fibers 204, respectively.

The second MUX/DEMUX 241 demultiplexes the multiplexed downstream optical signal output from the central office 210, and outputs the resultant demultiplexed downstream optical signals to respective subscribers 250. The second MUX/DEMUX 241 also multiplexes the upstream optical signals output from respective subscribers 250, and outputs the resultant multiplexed upstream optical signal to the central office 210. The second MUX/DEMUX 241 also demultiplexes the monitoring light into channels, and outputs the channels to respective subscribers 250. In addition, the second MUX/DEMUX 241 multiplexes the channels reflected from respective subscribers 250, and outputs the multiplexed channel signal to the central office 210.

Each subscriber 250 is linked to the remote node 240 via an associated one of the second main optical fibers 203 and an associated one of the second auxiliary optical fibers 204. Each subscriber 250 includes an upstream light source 251, a downstream photodetector 252, a fifth optical switch 254, a fourth wavelength-selective coupler 253, and first and second reflection filters 256 and 257.

The upstream light source 251 generates an upstream optical signal wavelength-locked by the second broadband light source 222. The downstream photodetector 252 detects an associated one of the demultiplexed downstream optical signals output from the remote node 240.

The fourth wavelength-selective coupler 253 receives the associated downstream optical signal from the fifth optical switch 254, and outputs the received associated downstream optical signal to the downstream photodetector 252. The fourth wavelength-selective coupler 253 also outputs the upstream optical signal generated from the upstream light source 251 to the fifth optical switch 254. The fifth optical switch 254 selectively connects the fourth wavelength-selective coupler 253 to the first reflection filter 256 or second reflection filter 257.

The first and second reflection filters 256 and 257 transmit the upstream optical signal and downstream optical signal, while reflecting, to the remote node 240, an associated one of the channels output from the remote node 240.

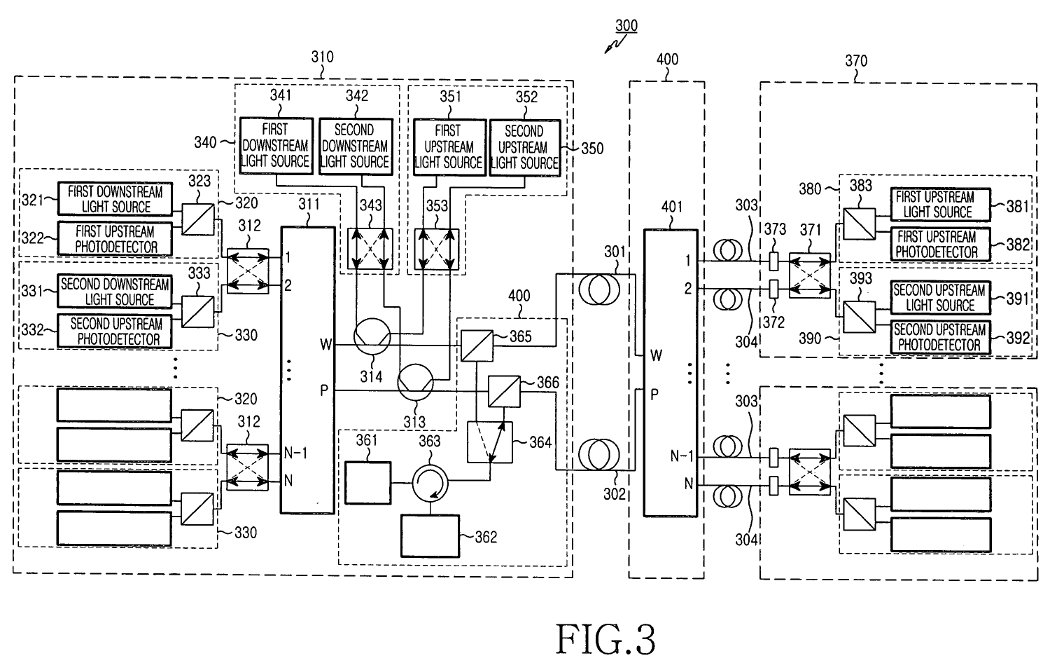

FIG. 3 is a block diagram illustrating a WDM PON 300 having self-monitoring and self-healing functions in accordance with a second embodiment of the present invention. The WDM PON 300 includes a plurality of subscribers 370 that generate upstream optical signals and can detect downstream optical signals associated with the subscribers 370, respectively, a central office 310 that generates a multiplexed downstream optical signal and can detect upstream optical signals, and a remote node 400 that performs a relay operation between the subscribers 370 and the central office 310. The WDM PON 200 also includes a first main optical fiber 301 and a first auxiliary optical fiber 302 to link the central office 310 and the remote node 400, and a plurality of second main optical fibers 303 and a plurality of second auxiliary optical fiber 304 to link the remote node 400 and respective subscribers 370.

The central office 310 includes at least a first optical transmitting/receiving module 320, at least a second optical transmitting/receiving module 330, a downstream optical module 340, an upstream optical module 350, a monitor 360, first optical switches 312, a first optical distributor 314, and a second optical distributor 313.

Each first optical transmitting/receiving module 320 includes a first downstream light source 321, a first upstream photodetector 322, and a first wavelength-selective coupler 323. The first wavelength-selective coupler 323 of each first optical transmitting/receiving module 320 outputs an associated downstream optical signal to an associated one of the first optical switches 312, and outputs an upstream optical signal received from the associated first optical switch 312 to an associated one of the first upstream photodetector 322. In this way, the first downstream light source 321 of each first optical transmitting/receiving module 320 generates a wavelength-locked downstream optical signal, and the first upstream photodetector 322 detects an associated upstream optical signal.

Each second optical transmitting/receiving module 330 operates when a fault occurs in an associated one of the first optical transmitting/receiving modules 320. The second optical transmitting/receiving module 330 includes a second downstream light source 331 to generate a downstream optical signal, a second upstream photodetector 332 to detect an associated upstream optical signal, and a second wavelength-selective coupler 333 to output the downstream optical signal generated from the second downstream light source 331 to an associated one of the first optical switches 312, and to output an upstream optical signal received from the associated first optical switch 312 to the second upstream photodetector 332. In this way each second optical transmitting/receiving module 330 is substituted for the associated first optical transmitting/receiving module 320 when the associated first optical transmitting/receiving module 320 cannot perform normal operation due to a fault condition.

The downstream optical module 340 includes first and second downstream light sources 341 and 342 that generate a downstream light, and a second optical switch 343 that outputs the downstream light generated from the first or second downstream light source 341 or 342 to the first optical distributor 314 or second optical distributor 313. The second optical switch 343 outputs the downstream light generated from the second downstream light source 342 when there is a fault in the first downstream light source 341, and outputs the downstream light generated from the first downstream light source 341 when there is a fault in the second downstream light source 342.

The upstream optical module 350 includes first and second upstream light sources 351 and 352 that generate an upstream light to wavelength-lock the subscribers 370, and a third optical switch 353 that outputs the upstream light generated from the first or second upstream light source 351 or 352 to the first optical distributor 314 or second optical distributor 313. The third optical switch 353 outputs the upstream light generated from the second downstream light source 352 when there is a fault in the first upstream light source 351, and outputs the upstream light generated from the first upstream light source 351 when there is a fault in the second upstream light source 352.

The first MUX/DEMUX 311 multiplexes the downstream optical signals respectively received from the first optical switches 312, and outputs the resultant multiplexed downstream optical signal to the remote node 400. The first MUX/DEMUX 311 also demultiplexes a multiplexed upstream optical signal received from the remote node 400, and outputs the resultant demultiplexed upstream optical signals to the first optical switches 312 associated therewith, respectively.

The monitor 360 includes a monitoring light source 361 that generates a monitoring light, a spectrum analyzer 362, a second wavelength-selective coupler 365 arranged on the first main optical fiber 301, a third wavelength-selective coupler 366 arranged on the first auxiliary optical fiber 302, and a fourth optical switch 364 to selectively connect the monitor 360 to the second wavelength-selective coupler 365 or third wavelength-selective coupler 366. The monitor 360 also includes a circulator 363 that outputs the monitoring light generated from the monitoring light source 361 to the fourth optical switch 364, and outputs a multiplexed channel signal including a plurality channels having different wavelengths received from the fourth optical switch 364 to the spectrum analyzer 362.

The monitoring light source 361 outputs the monitoring light generated therefrom to the circulator 363. The spectrum analyzer 362 demultiplexes the multiplexed channel signal from the remote node 400 via the circulator 363, and detects the resultant demultiplexed channels. The spectrum analyzer 362 may include a diffraction grating to split the multiplexed channel signal into channels having different wavelengths, and photodetectors to detect the split channels outputted from the diffraction grating, respectively. For the diffraction grating, a Bragg grating or hologram element may be used. For the photodetectors, photodiodes capable of detecting the channels of different wavelengths may be used, respectively.

The second wavelength-selective coupler 365 outputs the monitoring light to the remote node 400 via the first main optical fiber 301, and outputs the multiplexed channel signal received from the remote node 400 via the first main optical fiber 301 to the fourth optical switch 364. The third wavelength-selective coupler 366 outputs the monitoring light to the remote node 400 via the first auxiliary optical fiber 302, and outputs the multiplexed channel signal received from the remote node 400 via the first auxiliary optical fiber 302 to the fourth optical switch 364. The fourth optical switch 364 selectively couples the circulator 363 to the second wavelength-selective coupler 365 or third wavelength-selective coupler 366. The circulator 363 outputs the monitoring light generated from the monitoring light source 361 to the fourth optical switch 364, and outputs the multiplexed channel signal received from the fourth optical switch 364 to the spectrum analyzer 362.

Each first optical switch 312 selectively connects the associated first optical transmitting/receiving module 320 or the associated second optical transmitting/receiving module 330 to the first MUX/DEMUX 311.

The first optical distributor 314, which is arranged on the first main optical fiber 301, is connected to both the downstream optical module 340 and the upstream optical module 350, to output the downstream light to the first MUX/DEMUX 311, and to output the upstream light to the remote node 400.

The second optical distributor 313, which is arranged on the first auxiliary optical fiber 302, is connected to both the downstream optical module 340 and the upstream optical module 350, to output the downstream light to the first MUX/DEMUX 311, and to output the upstream light to the remote node 400.

The remote node 400 includes a second MUX/DEMUX 401. The second MUX/DEMUX 401 is linked to the central office 310 via the first main optical fiber 301 and first auxiliary optical fiber 302. The second MUX/DEMUX 401 is also linked to the subscribers 370 via the second main optical fibers 303 and second auxiliary optical fibers 304, respectively.

Each subscriber 370 includes a first optical module 380 that generates a wavelength-locked upstream optical signal, a second optical module 390 that generates a wavelength-locked upstream optical signal, a fifth optical switch 371 that selectively connects the first optical module 380 or second optical module 390 to the remote node 400, a first band-pass filter 373 arranged on an associated one of the second main optical fibers 303, and a second band-pass filter 372 arranged on an associated one of the second auxiliary optical fibers 304.

The fifth optical switch 371 of each subscriber 370 outputs the upstream optical signal generated from the associated second optical module 390 when a fault occurs in the associated first optical module 380, and outputs an associated one of the demultiplexed downstream optical signals output from the remote node 400 to the associated second optical module 390. The fifth optical switch 371 also connects the associated second auxiliary optical fiber 304 to the first optical module 380 or second optical module 390 when a fault occurs in the associated second main optical fiber 303.

The first band-pass filter 373 of each subscriber 370 outputs the downstream optical signal received via the associated second main optical fiber 303 to the associated fifth optical switch 371, and outputs the upstream optical signal generated from the associated first or second optical module 380 or 390 to the remote node 400 via the associated second main optical fiber 303. The first band-pass filter 373 also reflects the associated channel received from the remote node 400 to the remote node 400.

The second band-pass filter 372 of each subscriber 370 outputs the downstream optical signal received via the associated second auxiliary optical fiber 304 to the associated fifth optical switch 371, and outputs the upstream optical signal generated from the associated first or second optical module 380 or 390 to the remote node 400 via the associated second auxiliary optical fiber 304.

The first optical module 380 of each subscriber 370 includes a first downstream photodetector 382 that detects the associated downstream optical signal, a first upstream light source 381 that generates a wavelength-locked upstream optical signal, and a fifth wavelength-selective coupler 383. The fifth wavelength-selective coupler 383 outputs the associated downstream optical signal received from the associated fifth optical switch 371 to the associated first downstream photodetector 382, and outputs the upstream optical signal received from the associated first upstream light source 381 to the associated fifth optical switch 371.

The second optical module 390 of each subscriber 370 includes a second downstream photodetector 392 that detects the associated downstream optical signal, a second upstream light source 391 that generates a wavelength-locked upstream optical signal, and a sixth wavelength-selective coupler 393. The sixth wavelength-selective coupler 393 outputs the associated downstream optical signal received from the associated fifth optical switch 371 to the associated second downstream photodetector 392, and outputs the upstream optical signal received from the associated second upstream light source 391 to the associated fifth optical switch 371. The second optical module 390 operates in place of the first optical module 380 when the first optical module 380 cannot perform normal operation due to a fault condition or cannot generate a desired upstream optical signal.

While various embodiments of the present invention has been described above, it is to be understood that the invention is not limited to the disclosed embodiment, but, on the contrary, it is intended to cover various modifications within the spirit and scope of the appended claims.

1. A passive optical network comprising:
a plurality of subscribers units arranged to generate upstream optical signals, respectively, to reflect channels applied thereto in association with the subscribers units, respectively, and to detect downstream optical signals associated with the subscribers units, respectively;
a central office arranged to output a multiplexed downstream optical signal and a monitoring light, and to detect a multiplexed channel signal;
a remote node arranged to demultiplex the monitoring light into different channels, to output the channels to the subscribers, respectively, to multiplex the channels, which are reflected from the subscribers units, to generate the multiplexed channel signal, and to output the multiplexed channel signal to the central office;
a first main optical fiber to link the central office and the remote node; and
a plurality of second main optical fibers to link the remote node and the subscribers, respectively.

2. The passive optical network according to claim 1, further comprising:
a first auxiliary optical fiber to transmit the multiplexed downstream optical signal and the monitoring light to the remote node and transmit a multiplexed signal of the upstream optical signals and a multiplexed signal of the channels to the central office when a fault occurs in the first main optical fiber; and
a plurality of second auxiliary optical fibers each to transmit an associated one of demultiplexed signals of the multiplexed downstream optical signal to an associated one of the subscriber units and transmit the upstream optical signal generated from an associated one of the subscriber units and the channel reflected from the associated subscriber unit to the remote node when a fault occurs between the remote node and the associated subscriber unit.

3. The passive optical network according to claim 1, wherein the central office comprises:
a plurality of downstream light sources arranged to generate the downstream optical signals, respectively;
a plurality of upstream photodetectors arranged to detect the upstream optical signals, respectively;
a monitor arranged to generate the monitoring light, to output the generated monitoring light to the remote node, and to detect the channels respectively reflected from the subscriber units;
a first multiplexer/demultiplexer arranged to multiplex the downstream optical signals, to output the resultant multiplexed downstream optical signal to the remote node, to demultiplex a multiplexed signal of the upstream optical signals output from the remote node, and to output the resultant demultiplexed upstream optical signals to the upstream photodetectors, respectively; and
a broadband optical module to wavelength-lock the downstream light sources and the subscriber units.

4. The passive optical network according to claim 3, wherein the central office further comprises:
a plurality of wavelength-selective couplers arranged to output the upstream optical signals to the upstream photodetectors, respectively, and to output the downstream optical signals generated from the downstream light sources to the multiplexer/demultiplexer, respectively; and
a plurality of optical switches each arranged between an associated one of the first wavelength-selective couplers and the multiplexer/demultiplexer to selectively connect the associated first wavelength-selective coupler and one of at least two ports of the multiplexer/demultiplexer assigned to the associated first wavelength-selective coupler.

5. The passive optical network according to claim 3, wherein the monitor comprises:
a monitoring light source arranged to generate the monitoring light;
a spectrum analyzer arranged to demultiplex the multiplexed channel signal, and to detect the resultant demultiplexed channels;
a second wavelength-selective coupler connecting the monitor and the first main optical fiber;
a third wavelength-selective coupler connecting the monitor and the first auxiliary optical fiber;
a second optical switch arranged to output the monitoring light to the remote node via the second wavelength-selective coupler or the third wavelength-selective coupler, and to receive the multiplexed channel signal from the remote node via the first wavelength-selective coupler or the second wavelength-selective coupler; and
a circulator arranged to output the monitoring light from the monitoring light source to the second optical switch, and to output the multiplexed channel signal from the second optical switch to the spectrum analyzer.

6. The passive optical network according to claim 1, wherein the remote node comprises a second multiplexer/demultiplexer.

7. The passive optical network according to claim 1, wherein each of the subscriber units comprises:
a downstream photodetector arranged to detect an associated one of the demultiplexed downstream optical signals;
an upstream light source arranged to generate an associated one of the upstream optical signals;
a fourth wavelength-selective coupler arranged to output the associated upstream optical signal to the remote node, and to output an associated one of the demultiplexed downstream optical signals to the downstream photodetector;
a third optical switch connecting the fourth wavelength-selective coupler to an associated one of the second main optical fibers or an associated one of the second auxiliary optical fibers;
a first reflection filter arranged on the associated second main optical fiber between the optical switch and the remote node to reflect an associated one of the channels output from the remote node to the remote node; and
a second reflection filter arranged on the associated second auxiliary optical fiber between the third optical switch and the remote node to reflect the associated channel outputted from the remote node to the remote node.

8. The passive optical network according to claim 3, wherein the broadband optical module comprises:
a first broadband light source arranged to generate a downstream light to induce wavelength-locking of the multiplexed downstream optical signal;
a second broadband light source arranged to generate an upstream light to induce wavelength-locking of the multiplexed upstream optical signal;
a first optical distributor arranged on the first main optical fiber to output the downstream light to the first multiplexer/demultiplexer, and to output the upstream light to the second wavelength-selective coupler;
a second optical distributor arranged on the first auxiliary optical fiber to output the upstream light to the third wavelength-selective coupler, and to output the downstream light to the first multiplexer/demultiplexer;
a third optical switch connecting the first broadband light source to the first optical distributor or the second optical distributor; and
a fourth optical switch connecting the second broadband light source to the first optical distributor or the second optical distributor.

9. The passive optical network according to claim 4, wherein the broadband optical module comprises:
a first broadband light source arranged to generate a downstream light to induce wavelength-locking of the multiplexed downstream optical signal;
a second broadband light source arranged to generate an upstream light to induce wavelength-locking of the multiplexed upstream optical signal;
a first optical distributor arranged on the first main optical fiber to output the downstream light to the first multiplexer/demultiplexer, and to output the upstream light to the second wavelength-selective coupler;
a second optical distributor arranged on the first auxiliary optical fiber to output the upstream light to the third wavelength-selective coupler, and to output the downstream light to the first multiplexer/demultiplexer;
a third optical switch connecting the first broadband light source to the first optical distributor or the second optical distributor; and
a fourth optical switch connecting the second broadband light source to the first optical distributor or the second optical distributor.

10. The passive optical network according to claim 5, wherein the broadband optical module comprises:
a first broadband light source arranged to generate a downstream light to induce wavelength-locking of the multiplexed downstream optical signal;
a second broadband light source arranged to generate an upstream light to induce wavelength-locking of the multiplexed upstream optical signal;
a first optical distributor arranged on the first main optical fiber to output the downstream light to the first multiplexer/demultiplexer, and to output the upstream light to the second wavelength-selective coupler;
a second optical distributor arranged on the first auxiliary optical fiber to output the upstream light to the third wavelength-selective coupler, and to output the downstream light to the first multiplexer/demultiplexer;
a third optical switch connecting the first broadband light source to the first optical distributor or the second optical distributor; and
a fourth optical switch connecting the second broadband light source to the first optical distributor or the second optical distributor.

11. A passive optical network comprising:
a plurality of subscriber units arranged to generate upstream optical signals, respectively, to reflect channels applied thereto in association with the subscribers unit, respectively, and to detect downstream optical signals associated with the subscriber units, respectively;
a central office arranged to output a multiplexed downstream optical signal and a monitoring light, and to detect a multiplexed channel signal;
a remote node arranged to demultiplex the monitoring light into different channels, to output the channels to the subscriber units, respectively, to multiplex the channels, which are reflected from the subscriber units, to generate the multiplexed channel signal, and to output the multiplexed channel signal to the central office;
a first main optical fiber linking the central office and the remote node;
a plurality of second main optical fibers linking the remote node and the subscribers, respectively;
a first auxiliary optical fiber arranged to transmit the multiplexed downstream optical signal and the monitoring light to the remote node when a fault occurs in the first main optical fiber, and to transmit a multiplexed signal of the upstream optical signals and a multiplexed signal of the channels to the central office when the fault occurs; and
a plurality of second auxiliary optical fibers each arranged to transmit an associated one of demultiplexed signals of the multiplexed downstream optical signal to an associated one of the subscriber units and transmit the upstream optical signal generated from the associated subscriber unit and the channel reflected from the associated subscriber unit to the remote node when a fault occurs in an associated one of the second main optical fibers.

12. The passive optical network according to claim 11, wherein the central office comprises:
a plurality of first optical transmitting/receiving modules each arranged to generate an associated one of the downstream optical signals, and to detect an associated one of the upstream optical signals;
a plurality of second optical transmitting/receiving modules each arranged to generate an associated one of the downstream optical signals and detect an associated one of the upstream optical signals when a fault occurs in an associated one of the first optical transmitting/receiving modules;
a first multiplexer/demultiplexer arranged to multiplex the downstream optical signals, to output the resultant multiplexed downstream optical signal to the remote node, and to demultiplex a multiplexed signal of the upstream optical signals;
a downstream optical module arranged to generate a downstream light to wavelength-lock the first and second optical transmitting/receiving modules;
an upstream optical module arranged to generate an upstream light to wavelength-lock the subscribers; and
a monitor arranged to generate a monitoring light, and to detect the channels multiplexed by the remote node.

13. The passive optical network according to claim 12, wherein the central office further comprises:
a plurality of first optical switches each connecting an associated one of the first optical transmitting/receiving module or an associated one of the second optical transmitting/receiving module to the first multiplexer/demultiplexer;
a first optical distributor arranged on the first main optical fiber to be connected to the downstream optical module and the upstream optical module, to output the downstream light to the first multiplexer/demultiplexer, and to output the upstream light to the remote node; and
a second optical distributor arranged on the first auxiliary optical fiber to be connected to the downstream optical module and the upstream optical module, to output the downstream light to the first multiplexer/demultiplexer, and to output the upstream light to the remote node.

14. The passive optical network according to claim 12, wherein each of the first optical transmitting/receiving modules comprises:
a first downstream light source arranged to generate an associated one of the downstream optical signals;
an first upstream photodetector arranged to detect an associated one of the upstream optical signals; and
a first wavelength-selective coupler arranged to output the associated downstream optical signal to an associated one of the first optical switches, and to output the associated upstream optical signal received from the first associated optical switch to the first upstream photodetector.

15. The passive optical network according to claim 13, wherein each of the first optical transmitting/receiving modules comprises:
a first downstream light source arranged to generate an associated one of the downstream optical signals;
an first upstream photodetector arranged to detect an associated one of the upstream optical signals; and
a first wavelength-selective coupler arranged to output the associated downstream optical signal to an associated one of the first optical switches, and to output the associated upstream optical signal received from the first associated optical switch to the first upstream photodetector.

16. The passive optical network according to claim 12, wherein each of the second optical transmitting/receiving modules comprises:
a second downstream light source arranged to generate an associated one of the downstream optical signals when a fault occurs in an associated one of the first optical transmitting/receiving modules;
an second upstream photodetector arranged to detect an associated one of the upstream optical signals; and
a second wavelength-selective coupler arranged to output the associated downstream optical signal to an associated one of the first optical switches, and to output the associated upstream optical signal received from the first associated optical switch to the second upstream photodetector.

17. The passive optical network according to claim 13, wherein each of the second optical transmitting/receiving modules comprises:
a second downstream light source arranged to generate an associated one of the downstream optical signals when a fault occurs in an associated one of the first optical transmitting/receiving modules;
an second upstream photodetector arranged to detect an associated one of the upstream optical signals; and
a second wavelength-selective coupler arranged to output the associated downstream optical signal to an associated one of the first optical switches, and to output the associated upstream optical signal received from the first associated optical switch to the second upstream photodetector.

18. The passive optical network according to claim 12, wherein the downstream optical module comprises:
a first wavelength-locking downstream light source arranged to generate the downstream light to wavelength-lock the downstream optical signals;
a second wavelength-locking downstream light source arranged to generate the downstream light to wavelength-lock the downstream optical signals; and
an optical switch to output the downstream light generated from the second wavelength-locking downstream light source to the second optical distributor when a fault occurs in the first wavelength-locking downstream light source.

19. The passive optical network according to any one of claim 14, wherein the downstream optical module comprises:
a first wavelength-locking downstream light source arranged to generate the downstream light to wavelength-lock the downstream optical signals;
a second wavelength-locking downstream light source arranged to generate the downstream light to wavelength-lock the downstream optical signals; and
an optical switch to output the downstream light generated from the second wavelength-locking downstream light source to the second optical distributor when a fault occurs in the first wavelength-locking downstream light source.

20. The passive optical network according to claim 12, wherein the upstream optical module comprises:
a first wavelength-locking upstream light source arranged to generate the upstream light to wavelength-lock the subscribers;
a second wavelength-locking upstream light source arranged to generate the upstream light to wavelength-lock the subscribers; and
an optical switch to output the upstream light generated from the second wavelength-locking upstream light source to the second optical distributor when a fault occurs in the first wavelength-locking upstream light source.

21. The passive optical network according to claim 14, wherein the upstream optical module comprises:
a first wavelength-locking upstream light source arranged to generate the upstream light to wavelength-lock the subscribers;
a second wavelength-locking upstream light source arranged to generate the upstream light to wavelength-lock the subscribers; and
an optical switch to output the upstream light generated from the second wavelength-locking upstream light source to the second optical distributor when a fault occurs in the first wavelength-locking upstream light source.

22. The passive optical network according to claim 12, wherein the monitor comprises:
a monitoring light source arranged to generate the monitoring light;
a spectrum analyzer arranged to demultiplex the multiplexed channel signal outputted from the remote node, and to detect the resultant demultiplexed channels;
a second wavelength-selective coupler arranged on the first main optical fiber to output the monitoring light to the remote node, and to output the multiplexed channel signal from the remote node to the spectrum analyzer;
a third wavelength-selective coupler arranged on the first auxiliary optical fiber to output the monitoring light to the remote node, and to output the multiplexed channel signal from the remote node to the spectrum analyzer;
a fourth optical switch selectively connecting the monitor to the second wavelength-selective coupler or the third wavelength-selective coupler; and
a circulator arranged to output the monitoring light generated from the monitoring light source to the fourth optical switch, and to output the multiplexed channel signal received from the fourth optical switch to the spectrum analyzer.

23. The passive optical network according to claim 11, wherein the remote node comprises:
a second multiplexer/demultiplexer linked to the central office via the first main optical fiber and the first auxiliary optical fiber while being linked to the subscribers via the second main optical fibers and the second auxiliary optical fibers, respectively.

24. The passive optical network according to claim 11, wherein each of the subscribers comprises:
a first optical module arranged to detect an associated one of the downstream optical signals, and to generate a wavelength-locked upstream optical signal;
a second optical module arranged to detect the associated downstream optical signal, and to generate the wavelength-locked upstream optical signal;
an fifth optical switch linking the second optical module to the remote node when a fault occurs in the first optical module, and selectively connecting the first optical module or the second optical module to the remote node;
a first band-pass filter arranged to output the associated downstream optical signal received via an associated one of the second main optical fibers to the fifth optical switch, to output the wavelength-locked upstream optical signal to the remote node via the associated second main optical fiber, and to reflect an associated one of the channels output from the remote node to the remote node; and
a second band-pass filter arranged to output the associated downstream optical signal received via an associated one of the second auxiliary optical fibers to the fifth optical switch, to output the wavelength-locked upstream optical signal to the remote node via the associated second main optical fiber, and to reflect the associated channel output from the remote node to the remote node.

25. The passive optical network according to claim 24, wherein the first optical module comprises:
a first downstream photodetector arranged to detect the associated downstream optical signal;
a first upstream light source arranged to generate the wavelength-locked upstream optical signal; and
a fifth wavelength-selective coupler arranged to output the associated downstream optical signal received from the fifth optical switch to the first downstream photodetector, and to output the upstream optical signal received from the first upstream light source to the fifth optical switch.

26. The passive optical network according to claim 24, wherein the second optical module comprises:
a second downstream photodetector arranged to detect the associated downstream optical signal;
an second upstream light source arranged to generate the wavelength-locked upstream optical signal; and
a sixth wavelength-selective coupler arranged to output the associated downstream optical signal received from the fifth optical switch to the second downstream photodetector, and to output the upstream optical signal received from the second upstream light source to the fifth optical switch,
wherein the second optical module operates when a fault occurs in the first optical module.

27. A method for a WDM PON comprising the steps of:
receiving a monitoring light from a remote center;
demultiplexes the monitoring light into channels of different wavelengths;
outputting the demultiplexed channels to a plurality of the subscriber units respectively;
each subscriber unit that receives one of the demultiplezed channels, reflecting the received channel back;
multiplexing the reflected channels received from respective subscriber units; and
outputting the multiplexed channel signal to the remote center.

28. The method according to claim 27, further comprising the step of
monitoring, by the remote center, whether or not there is a fault in the WDM PON using the multiplexed channel signal by determining whether or not the reflected channel from each subscriber unit has been detected.
